(19) United States
(12) Patent Application Publication
(10) Pub. No.: US 2012/0186392 A1
(43) Pub. Date: Jul. 26, 2012

(54) HYBRID DRIVE TRAIN

(75) Inventors: James Antony Lethbridge, Bentley Heath (GB); Dierk Reitz, Baden-Baden (DE)

(73) Assignee: Schaeffler Technologies AG & Co. KG, Herzogenaurach (DE)

(21) Appl. No.: 13/338,573

(22) Filed: Dec. 28, 2011

Related U.S. Application Data
(63) Continuation of application No. PCT/DE2010/000690, filed on Jun. 17, 2010.

(30) Foreign Application Priority Data
Jul. 2, 2009 (DE) 102009031513.6

(51) Int. Cl. F16H 3/08

(52) U.S. Cl. 74/665 A

(57) ABSTRACT

A drive train (1) for a motor vehicle, comprising a combustion engine (2), an electric machine (29) and an automatic shift transmission (6) having a transmission input shaft (5) and a transmission output shaft (12), with a shifting actuator for selecting gear trains (7, 8, 9, 10, 11) situated between the transmission input shaft (5) and the transmission output shaft (12), acting as gears (I, II, III, IV, R), as well as a single automated friction clutch (4) situated between a crankshaft (3) of the combustion engine (2) and the transmission input shaft (5) of the shift transmission (6), wherein the electric machine (29) is switchable alternatively between the crankshaft (3) and the shift transmission (6).

### CROSS-REFERENCE TO RELATED APPLICATIONS

This application is filed under 35 U.S.C. §120 and §365(c) as a continuation of International Patent Application No. PCT/DE2010/000690 filed Jun. 17, 2010, which application claims priority from German Patent Application No. DE 10 2009 031 513.6 filed Jul. 2, 2009, which applications are incorporated herein by reference in their entireties.

### FIELD OF THE INVENTION

The invention relates to a hybrid drive train comprising an internal combustion engine, an electric machine, an automatic shift transmission and a single automated friction clutch situated between a crankshaft of the internal combustion engine and the transmission input shaft of the transmission.

### BACKGROUND OF THE INVENTION

Drive trains of this species have already been proposed for use in motor vehicles. For example, electric machines connected to the crankshaft, with the friction clutch disengaged, are able to start the internal combustion engine and make a boost mode possible, in which the electric machine supports the internal combustion engine in particular during an acceleration of the motor vehicle. Purely electrical operation or recuperation, i.e., conversion of the kinetic energy of the motor vehicle during deceleration while it is being braked, is possible only to a limited degree, since the drag torque of the internal combustion engine interferes and reduces efficiency. Furthermore, replenishment of the propulsive power is not possible during shifting of the transmission.

A drive train for a motor vehicle is known from DE 199 60 621 A1, in which a single friction clutch is situated between an internal combustion engine and the transmission. An electric machine that is optionally connectible with the transmission input shaft or the transmission output shaft of the transmission is engaged with the transmission, so that when the friction clutch is disengaged and the internal combustion engine is possibly shut down it is possible to drive or to drive off electrically using the electric machine. At the same time, switching between transmission input shaft and transmission output shaft enables better utilization of the properties of the electric machine, optionally with or without use of the transmission ratio of the transmission and addition of another gear ratio between electric machine and transmission output shaft. To start the internal combustion engine, the electric machine must be connected to the transmission input shaft, all of the gears in the transmission must be disengaged, and the friction clutch must be engaged. In particular at low temperatures, the drag losses of the transmission input shaft increase the efficiency of the electric machine, and the efficiency of the battery is also low at these temperatures. Furthermore, driving off again may be poor, that is, delayed, in particular in stop-and-go situations, for example in traffic jams or at traffic lights, because a start-up gear must still first be engaged after the internal combustion engine is started.

### SUMMARY OF THE INVENTION

The present invention broadly comprises a drive train (1) for a motor vehicle, comprising a combustion engine (2), an electric machine (29) and an automatic shift transmission (6) having a transmission input shaft (5) and a transmission output shaft (12), with a shifting actuator for selecting gear trains (7, 8, 9, 10, 11) situated between the transmission input shaft (5) and the transmission output shaft (12), acting as gears (I, II, III, IV, R), as well as a single automated friction clutch (4) situated between a crankshaft (3) of the combustion engine (2) and the transmission input shaft (5) of the shift transmission (6), wherein the electric machine (29) is switchable alternatively between the crankshaft (3) and the shift transmission (6).

The object of the invention is therefore to propose a hybrid drive train in particular for a motor vehicle, having a single friction clutch situated between the internal combustion engine and the transmission, whose electric machine makes possible the functions of starting the internal combustion engine, recuperation, driving electrically, boost mode and electrical replenishment of the propulsion power with high efficiency during shifting of the transmission.

The problem is solved by a drive train for a motor vehicle comprising an internal combustion engine, an electric machine and an automatic shift transmission, having a transmission input shaft and a transmission output shaft with a shifting actuator for engaging gear trains acting as gear ratios, situated between the transmission input shaft and the transmission output shaft, as well as a single automated friction clutch situated between a crankshaft of the internal combustion engine and the transmission input shaft of the shift transmission, the electric machine being switchable alternatively between the crankshaft and the transmission. The electric machine in this case may be switchably connected to the transmission input shaft and/or to the transmission output shaft, directly or by means of an additional shifting clutch.

It has proven to be advantageous to execute the shifting of the electric machine independently of a shift state of the transmission, so that the electric machine may be connected to the crankshaft and the transmission input shaft as it were with each selected gear, and the electric machine may also be switched over during a gear change. In this case, advantageously no additional actuating system is provided, but rather the electric machine is switched using the shifting actuator. To this end appropriate switching means are provided, such as shifting clutches with sliding muff-type couplings, selector forks and selector rails, and are lined up with or between the shifting clutches to shift the gears. The connection to the transmission input shaft or the transmission output shaft may be accomplished via the gear wheel pairing of a gear ratio, so that in the event the electric machine is switched to the transmission, the electric machine is connected to the transmission input shaft if a gear is selected, and connected exclusively to the transmission output shaft if no gear is selected.

According to one advantageous exemplary embodiment, a shifting of the gears and switching of the electric machine is accomplished by means of a two-dimensionally repositionable selector shaft driven for example by one or more electric motors, having at least one actuating element, for example a selector finger, and/or by a shifting actuator containing auxiliary actuating elements, wherein a first direction of motion of the selector shaft is selected, for example when the selector shaft is displaced longitudinally, a selector position is selected by the at least one actuating element and is switched to a second direction of motion of the selector shaft, running essentially perpendicular to the first direction of motion, for example when the latter is twisted, starting from a zero position such as a neutral position, by means of the at least one actuating element. In this case a first actuating element such as a selector finger may be moved back into the zero position after a gear is shifted, and may optionally switch the electric machine by changing the first direction of motion, while a second actuating element optionally stabilizes the engaged gear in its shifted position, or when a different gear is being engaged, disengages the latter during the same motion of the selector shaft. A shifting principle of this sort has become known under the designation active interlock, and is explained in greater detail for example in DE 102 065 61 A1. In this way, switching of the electric machine is possible independent of the shifting of the gears. Provision is made in this case to switch the electric machine by the first or one of the second actuating elements between the crankshaft, a zero position and the transmission, for example between the transmission input shaft and/or the transmission output shaft.

According to one advantageous exemplary embodiment, an air conditioner compressor may be linked directly or detachably to the electric machine, so that the latter can preferably drive the air conditioner compressor in the event that it is not necessary to operate the electric machine. On the other hand, when the electric machine is not being operated, or is being operated only at partial load, the air conditioner compressor may be driven via the connection from the transmission, for example in non-recuperating drag mode.

The proposed drive train is suitable for operation at high efficiency when starting the internal combustion engine, using the electric machine with the friction clutch disengaged and the electric machine connected to the crankshaft. An especially high degree of efficiency is achieved in this case due to the direct connection with the crankshaft and elimination of the drag torque of the transmission components. When the electric machine is connected to the transmission, with the friction clutch disengaged, the motor vehicle can be set in motion, driven and recuperated under deceleration in an ideal manner, independently of the internal combustion engine, using the electric machine, through conversion of the kinetic energy into electrical energy by the electric machine. In this case an appropriate gear with a suitable gear ratio is selected. At the same time, the internal combustion engine may be operated for example at idle or may be shut down. To decelerate the vehicle especially effectively, the friction clutch may in addition be at least partly engaged, accepting a reduction in the efficiency of the recuperation, in order to achieve a more rapid slow-down, by using the drag torque of the internal combustion engine—preferably not running—to this end.

With the friction clutch slipping or engaged, the electric machine and the internal combustion engine can propel the motor vehicle jointly in boost mode.

Especially advantageous, with the electric machine connected or connectible to the transmission output shaft, is a drawing off of torque through a corresponding driving or driven state of the electric machine during shifting, depending on the driving situation under traction or drag, as well as when shifting up or down.

The invention will be explained in further detail on the basis of the exemplary embodiment depicted in the single figure. This shows a hybrid drive train in a schematic depiction.

### BRIEF DESCRIPTION OF THE DRAWINGS

The present invention will be explained in greater detail below on the basis of preferred exemplary embodiments, in combination with the pertinent figures. These show the following:

FIG. 1 shows drive train 1 in a schematic depiction, which for the sake of greater clarity of the transmission layout does not reproduce the actual geometric arrangement of the components. Drive train 1 contains a combustion machine 2—here in the form of an internal combustion engine—having a crankshaft 3 to which automatically operated friction clutch 4 is firmly attached. The output part is firmly connected to the transmission input shaft 5 of automatic shift transmission 6. Shift transmission 6 contains a plurality of gear trains 7, 8, 9, 10, 11 to form gears I, II, III, IV, R, gear R being the reverse gear, between transmission input shaft 5 and transmission output shaft 12, which is connected to the drive wheels 14 through the differential 13.

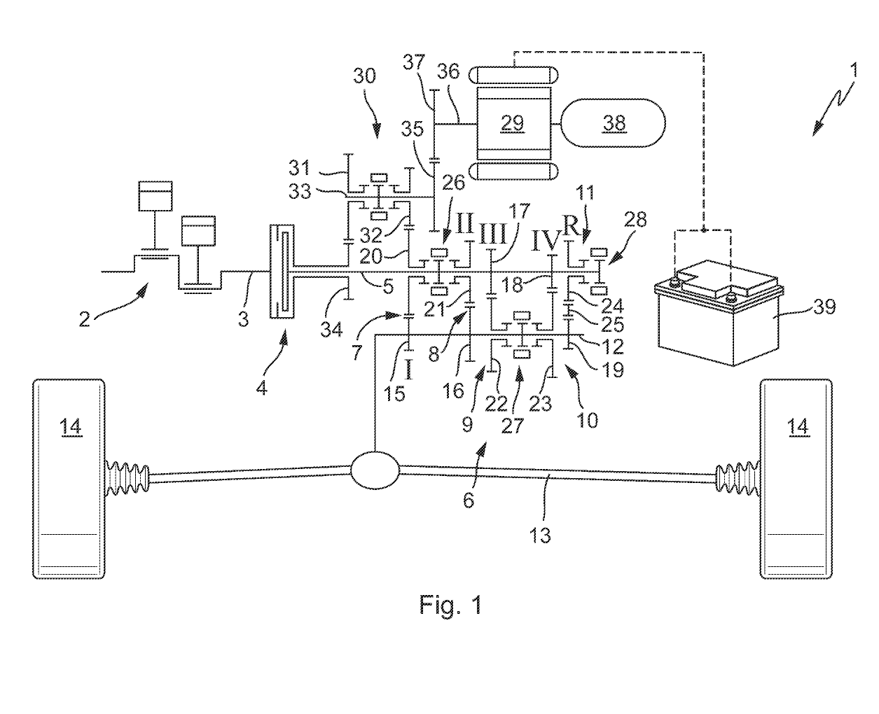

### DETAILED DESCRIPTION OF THE INVENTION

Gear trains 7, 8, 9, 10, 11 are formed of one fixed gear 15, 16, 17, 18, 19 and one idler gear 20, 21, 22, 23, 24 each, and in the case of the gear R, in addition by a reversing gear 25. When shifting of a gear is desired, idler gears 20, 21, 22, 23, 24 are each connected by a shifting clutch 26, 27, 28 to the appropriate shaft, such as the transmission input shaft 5 or transmission output shaft 12. This is done by an actuation activator, which according to the H shifting principle moves to a corresponding shifting clutch 26, 27, 28 through longitudinal movement of a selector shaft by an actuating element in a selection gate and selects the appropriate gear by turning, where aside from the reverse gear R, which has a separate shifting clutch 28, the other gears are engaged in pairs through selection of the direction of rotation of the selector shaft by a shifting clutch 26, 27. The depicted exemplary embodiment shows shift transmission 6 with five gears I, II, III, IV, R. It goes without saying that a different number of gears and a different arrangement and distribution of the transmission ratios of the individual pairs of gear wheels 7, 8, 9, 10 among the shift clutches 26, 27, 28 and their arrangement on transmission input shaft 5 or transmission output shaft 12 are included by the invention.

In the exemplary embodiment depicted, the electric machine 29 is connected to the auxiliary shaft 33 by means of an additional shifting clutch 30 operated by the shifting actuator, which connects the idler gears 31, 32 to the auxiliary shaft 33, or sets a neutral position in which none of the idler gears 31, 32 are connected to the auxiliary shaft, and therefore the electric machine 29 is completely uncoupled from drive train 1, and is optionally connectible to shift transmission 6 by means of fixed gear 34, which is firmly connected to the input part of friction clutch 4 and thus to crankshaft 3, or by means of idler gear 20 of gear I, which may be a start-up gear. Through the connection to the idler gear 20, when idler gear 32 is shifted the electric machine 29 is always connected to transmission output shaft 12 in a rotationally locked connection via fixed gear 15 of gear I. If gear I is selected, a connection is also made to transmission input shaft 5. Idler gear 32 is firmly connected to fixed gear 35, which meshes with the fixed gear 37 situated on rotor shaft 36 and sets a predefined transmission ratio. Air conditioner compressor 38 is situated coaxially to rotor shaft 36 and is driven by the latter. Electric machine 29 is fed by accumulator 39 or feeds electrical energy into the latter, depending on the operating mode as a motor or generator.

Shifting clutch 30 is arranged together with shifting clutches 26, 27, 28 to be operated jointly by the shifting actuator. In this case the shifting actuator, together with the corresponding actuating devices, is designed according to the active interlock principle, so that when one of the gears I, II, III, IV, R is selected, and independent of the shift state of the latter, electric machine 20 is connectible to crankshaft 3 or to transmission output shaft 12 by means of shifting clutch 30.

This arrangement results below, among other things, in the following operating modes:

Starting combustion engine 2:

Actuating shifting clutch 30 and thereby connecting idler gear 31 to fixed gear 34, so that electric machine 29 is connected to crankshaft 3. Disengaging friction clutch 4. Supplying electricity to electric machine 29 and thereby starting combustion engine 2. In this case a start-up gear, for example gear II, may already be selected, so that friction clutch 4 merely needs to be engaged to drive off immediately.

Driving with electric machine 29:

Actuating shifting clutch 30 to connect idler gear 32 to idler gear 20 of gear I. Supplying electricity to electric machine 29. The motor vehicle is propelled directly via fixed wheel 15.

Driving with combustion engine 2 supported by electric machine 29:

Actuating shifting clutch 30 to connect idler gear 32 to idler gear 20 of gear I. Supplying electricity to electric machine 29. Engaging friction clutch 4. In addition, another gear II, III, IV can be selected by means of shifting clutches 26, 27. When a predefined speed of rotor shaft 36 is reached with increasing speed of crankshaft 3 or transmission input shaft 5 during an acceleration process, the speed of rotor shaft 36 can be limited for example by a motor intervention into the control of combustion engine 2.

Recuperation:

Actuating shifting clutch 30 to connect idler gear 32 to idler gear 20 of gear I. Disengaging friction clutch 4. Operation of electric machine 29 in generator mode. Optionally, to increase the deceleration effect of the shut-down or idling combustion machine 2, friction clutch 4 may be at least partially engaged and its drag torque be used for deceleration.

Electric machine 29 in operation uncoupled from the shift transmission 6: Shifting of shifting clutch 30 into neutral position. Operation of air conditioner compressor 38 insofar as necessary. It goes without saying that in urgent cases air conditioner compressor 38 can also be driven in motor or generator mode. Alternatively, when electric machine 29 is not active, air conditioner compressor 38 can be driven with friction clutch 4 and idler gear 31 selected with a gear engaged or not engaged, or in deceleration mode with friction clutch 4 disengaged, by drive wheels 14 with idler gear 32 connected to auxiliary shaft 33, by turning rotor shaft 36 with electric machine 29 short-circuited.

Torque equalization by electric machine 29 while changing gears:

If the intention is to shift up or down from a gear I, II, III, IV into a different gear, during the gear change during upshifting or downshifting processes a loss of traction power occurs under traction and a torque overload occurs during a downshift under deceleration. To compensate, torque is fed accordingly into transmission input shaft 12 by means of electric machine 23, and is drawn off by generator operation in the event of a downshift under deceleration. To this end, shifting clutch 30 is actuated to connect idler gears 20, 32, and torque is fed in or drawn off.

### REFERENCE LABELS

1 drive train
2 combustion engine
3 crankshaft
4 friction clutch
5 transmission input shaft
6 shift transmission
7 gear train
8 gear train
9 gear train
10 gear train
11 gear train
12 transmission output shaft
13 differential
14 driving wheel
15 fixed gear
16 fixed gear
17 fixed gear
18 fixed gear
19 fixed gear
20 idler gear
21 idler gear
22 idler gear
23 idler gear
24 idler gear
25 reversing gear
26 shifting clutch
27 shifting clutch
28 shifting clutch
29 electric machine
30 shifting clutch
31 idler gear
32 idler gear
33 auxiliary shaft
34 fixed gear
35 fixed gear
36 rotor shaft
37 fixed gear
38 air conditioner compressor
39 accumulator
I gear
II gear
III gear
IV gear
R gear

What is claimed is:

1. A drive train (1) for a motor vehicle, comprising a combustion engine (2), an electric machine (29) and an automatic shift transmission (6) having a transmission input shaft (5) and a transmission output shaft (12), with a shifting actuator for selecting gear trains (7, 8, 9, 10, 11) situated between the transmission input shaft (5) and the transmission output shaft (12), acting as gears (I, II, III, IV, R), as well as a single automated friction clutch (4) situated between a crankshaft (3) of the combustion engine (2) and the transmission input shaft (5) of the shift transmission (6), wherein the electric machine (29) is switchable alternatively between the crankshaft (3) and the shift transmission (6).

2. The drive train (1) recited in claim 1, wherein the switching of the electric machine (29) occurs independently of a shift state of the shift transmission (6).

3. The drive train (1) recited in claim 2, wherein a switching of the electric machine (29) occurs by means of the shifting actuator.

4. The drive train (1) recited in claim 2, wherein a shifting of the gears (I, II, III, IV, R) and switching of the electric machine (29) is accomplished by means of the shifting actuator containing a two-dimensionally repositionable selector shaft having at least one actuating element, where in a first direction of motion of the selector shaft a selector position is selected by the at least one actuating element, and in a second direction of motion of the selector shaft running essentially perpendicular to the first direction of motion the selector shaft is switched starting from a zero position by means of the at least one actuating element.

5. The drive train (1) recited in claim 4, wherein a first actuating element is moved back into the zero position after the selection of a gear (I, II, III, IV, R) and optionally switches the electric machine (29), while a second actuating element optionally stabilizes the selected gear (I, II, III, IV, R) in its selector position, or deselects the latter during the same motion of the selector shaft when a different gear is being selected.

6. The drive train (1) recited in claim 5, wherein the electric machine (29) is switched between the crankshaft (3), a zero position and the transmission output shaft (12) by the first or one of the second actuating elements.

7. The drive train (1) recited in claim 1, wherein an air conditioner compressor (38) is driven directly by the electric machine (29).

8. The drive train (1) recited in claim 1, wherein when the friction clutch (4) is disengaged and the electric machine (29) is connected to the crankshaft (3), the combustion engine (2) is started by the latter.

9. The drive train (1) recited in claim 1, wherein under deceleration of the drive train (1) with friction clutch (4) disengaged, with combustion engine (2) possibly shut down and electric machine (29) connected to the shift transmission (6), as well as an appropriately selected gear (I, II, III, IV, R), kinetic energy is converted to electrical energy by the electric machine (29).

10. The drive train (1) recited in claim 1, wherein with friction clutch (4) disengaged, with combustion engine (2) possibly shut down and electric machine (29) connected to the shift transmission (6), as well as an appropriately selected gear (I, II, III, IV, R), driving or driving off is accomplished by means of the electric machine (29).

11. The drive train (1) recited in claim 1, wherein with friction clutch (4) slipping or engaged, combustion engine (2) running and electric machine (29) connected to the shift transmission (6), as well as an appropriately selected gear (I, II, III, IV, R), driving or driving off is accomplished by means of the electric machine (29) and the combustion engine (2).

12. The drive train (1) recited in claim 7, wherein the air conditioner compressor (38) is driven with the electric machine (29) not driving or recuperating.

13. The drive train (1) recited in claim 5, wherein with the electric machine (29) connected to the transmission output shaft (12), during a gear change the electric machine (29) is operated to compensate for a torque of the drive train (1).
